(19) United States
(12) Patent Application Publication
(10) Pub. No.: US 2006/0131386 A1
(43) Pub. Date: Jun. 22, 2006

(54) Transfer transaction system and method

(75) Inventor: Yoko Takano, Tokyo (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/262,948

(22) Filed: Nov. 1, 2005

(30) Foreign Application Priority Data
Dec. 16, 2004 (JP) 2004-364014

(51) Int. Cl. G07F 19/00

(52) U.S. Cl. 235/379

(57) ABSTRACT

A transfer transaction method whereby a terminal transmits inputted transfer information to a personal digital assistant (PDA) by a communicating device, the PDA which received the transfer information transmits the transfer information to an automatic transaction apparatus by a wireless communicating device. An automatic transaction apparatus performs a transfer transaction in accordance with the received transfer information. In the transfer transaction which is performed in the automatic transaction apparatus to pay a price of an article or the like purchased by the user, the operation to input the transfer information is simplified, the operating time of the user and the erroneous input are reduced and an operation burden can be reduced.

### BACKGROUND OF THE INVENTION

1. Field of the Invention

The invention relates to a transfer transaction system and its method and, more particularly, to a transfer transaction system using a personal digital assistant (PDA) and a transfer transaction method.

2. Related Background Art

In a conventional transfer transaction system, when the user transfers a price of a purchased article or the like by an automatic transaction apparatus, he visits a financial institution or the like and executes the operation to input transfer information such as transfer destination financial institution name, branch name, transfer destination account number, transfer money amount, transfer applicant name, telephone number of the transfer applicant, and the like while looking at a bill or the like.

There has also been proposed a transfer transaction system in which when the user purchases an article, transfer information such as money amount of the article, transfer destination account number, and the like is displayed by a display apparatus of a POS (Point Of Sales) terminal by a two-dimensional code, the 2-dimensional code is read by a personal digital assistant, the read transfer information is transmitted to the automatic transaction apparatus or the like, and a transfer transaction is executed, thereby paying the price of the article (for example, refer to JP-A-2002-109421 (paragraph Nos. “0023” to “0052”, FIG. 1)).

However, in the above conventional technique, although the user needs to execute the operation to input the transfer information disclosed in the bill or the like in the transfer transaction which is performed by the automatic transaction apparatus, since the input operation is complicated because the number of input items is large, there are such problems that it takes a very long time for the user inexperienced in the operation of the automatic transaction apparatus to execute the transfer transaction and that a mistake is liable to occur in the input operation and the user is burdened. There is also consequently such a problem that a waiting line for persons who use the automatic transaction apparatus is liable to occur.

Even in the case of reading the 2-dimensional code displayed on the POS terminal, transmitting the read transfer information to the automatic transaction apparatus or the like, and executing the transfer transaction, since it is necessary to read the 2-dimensional code by the PDA possessed by the user, there is such a problem that the user has to certainly visit a shop where he purchases the article.

The invention intends to solve such a problem.

### SUMMARY OF THE INVENTION

According to the invention, a transfer transaction system using a personal digital assistant (PDA) and a transfer transaction method are provided.

That is, according to the present invention, there is provided a transfer transaction method comprising the steps of:

allowing a terminal to transmit inputted transfer information to a personal digital assistant by communicating means;

allowing the personal digital assistant which has received the transfer information to transmit the transfer information to an automatic transaction apparatus by wireless communicating means; and

allowing the automatic transaction apparatus to perform a transfer transaction in accordance with the transfer information received by the wireless communicating means.

Moreover, in the transfer transaction method, the transfer information is a transfer destination financial institution name, a transfer destination branch name, a transfer destination account number, a transfer money amount, a requester name, a user name, and a telephone number of the user.

Moreover, in the transfer transaction method, the wireless communicating means is short range wireless communication such as infrared communication, contactless IC communication.

Further, according to the present invention, there is also provided a transfer transaction method comprising the steps of:

reading an information code printed on a bill by a personal digital assistant;

transmitting transfer information obtained by demodulating the information code to an automatic transaction apparatus by wireless communicating means; and

allowing the automatic transaction apparatus to perform a transfer transaction in accordance with the transfer information received by the wireless communicating means.

Moreover, in the transfer transaction method, the transfer information is a transfer destination financial institution name, a transfer destination branch name, a transfer destination account number, a transfer money amount, a requester name, a user name, and a telephone number of the user.

Moreover, in the transfer transaction method, the wireless communicating means is short range wireless communication such as infrared communication, contactless IC communication.

Furthermore, according to the present invention, there is provided a transfer transaction system comprising:

a personal digital assistant including a control unit which, when transfer information that is transmitted from a terminal is received, allows the transfer information to be stored into a storing unit and a wireless communicating means which transmits the transfer information in the storing unit to an automatic transaction apparatus,

wherein the automatic transaction apparatus includes a wireless communication control unit which, when the transmitted transfer information is received, allows the transfer information to be stored into a storing unit; and a transfer processing unit which fetches the transfer information from the storing unit and executes a transfer process.

Moreover, in the transfer transaction system, the transfer information is a transfer destination financial institution name, a transfer destination branch name, a transfer destination account number, a transfer money amount, a requester name, a user name, and a telephone number of the user.

Moreover, in the transfer transaction system, the wireless communicating means is short range wireless communication such as infrared communication, contactless IC communication.

Further, according to the present invention, there is also provided a transfer transaction system comprising:

a personal digital assistant including a code reading means which reads an information code indicative of transfer information printed on a bill; and a wireless communicating means which converts the read information code into the transfer information and transmits the converted transfer information to an automatic transaction apparatus,

wherein the automatic transaction apparatus includes a wireless communication control unit which, when the transmitted transfer information is received, allows the received transfer information to be stored into a storing unit; and a transfer processing unit which fetches the transfer information from the storing unit and executes a transfer process.

Moreover, in the transfer transaction system, the transfer information is a transfer destination financial institution name, a transfer destination branch name, a transfer destination account number, a transfer money amount, a requester name, a user name, and a telephone number of the user.

Moreover, in the transfer transaction system, the wireless communicating means is short range wireless communication such as infrared communication, contactless IC communication.

According to the invention as mentioned above, in the transfer transaction which is executed by the automatic transaction apparatus in order to pay the price of the article or the like purchased by the user, the operation to input the transfer information or the like is simplified, so that such an effect that the operating time of the user can be shortened, the erroneous input can be reduced, and the operation burden can be decreased is obtained.

The user can transfer the price of the purchased article or the like by the automatic transaction apparatus by using the PDA which has read the information code printed on the bill sent from the requester. Therefore, even if the user does not visit the shop as in a mail-order sale or the like, such an effect that the input operating time of the transfer transaction which is executed by the automatic transaction apparatus can be shortened, the erroneous input can be reduced, and the operation burden on the user can be decreased is obtained.

Further, such an effect that the waiting line for the automatic transaction apparatus can be shortened is also obtained.

The above and other objects and features of the present invention will become apparent from the following detailed description and the appended claims with reference to the accompanying drawings.

### BRIEF DESCRIPTION OF THE DRAWINGS

FIG. 1 is a block diagram of an automatic transaction system showing the first embodiment;

FIG. 2 is a block diagram of an automatic transaction apparatus showing the first embodiment;

FIG. 3 is a block diagram of a personal digital assistant (PDA) showing the first embodiment;

FIG. 4 is an explanatory diagram of an E-mail display screen which is displayed on a terminal and shows the first embodiment;

FIG. 5 is an explanatory diagram of a communication telegraphic message showing the first embodiment;

FIG. 6 is a flowchart showing the first embodiment;

FIG. 7 is a block diagram of a system construction showing the second embodiment; and

FIG. 8 is a flowchart showing the second embodiment.

### DETAILED DESCRIPTION OF THE PREFERRED EMBODIMENTS

An embodiment of a transfer transaction system according to the invention will be described hereinbelow with reference to the drawings.

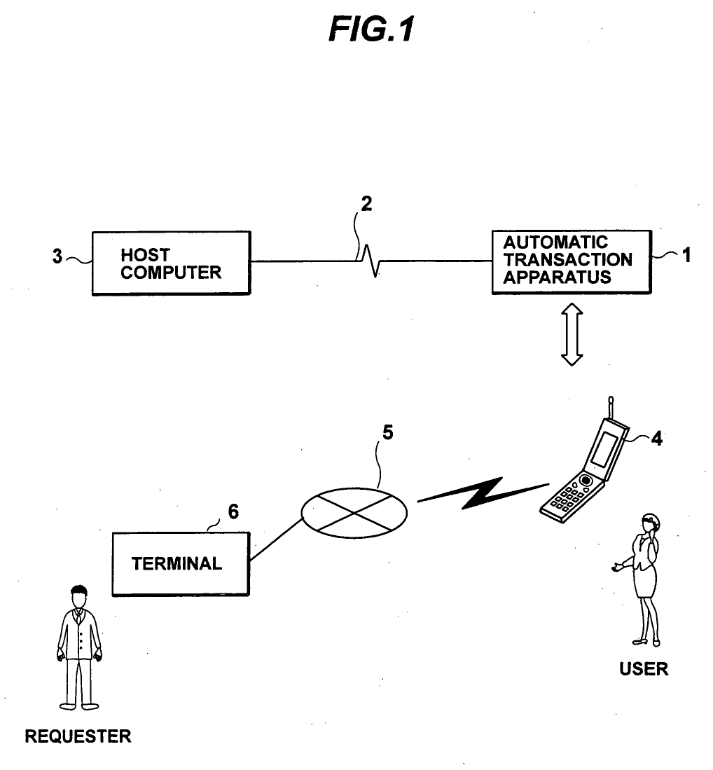

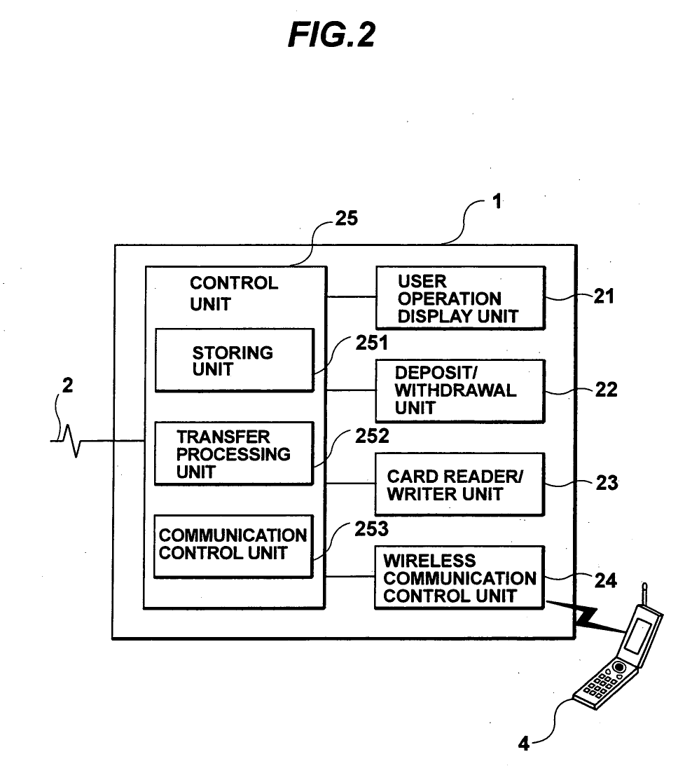

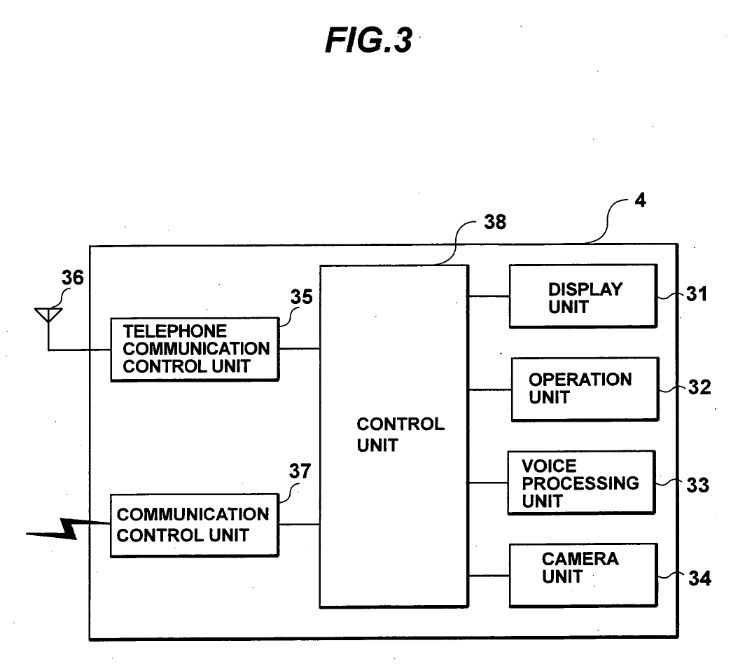

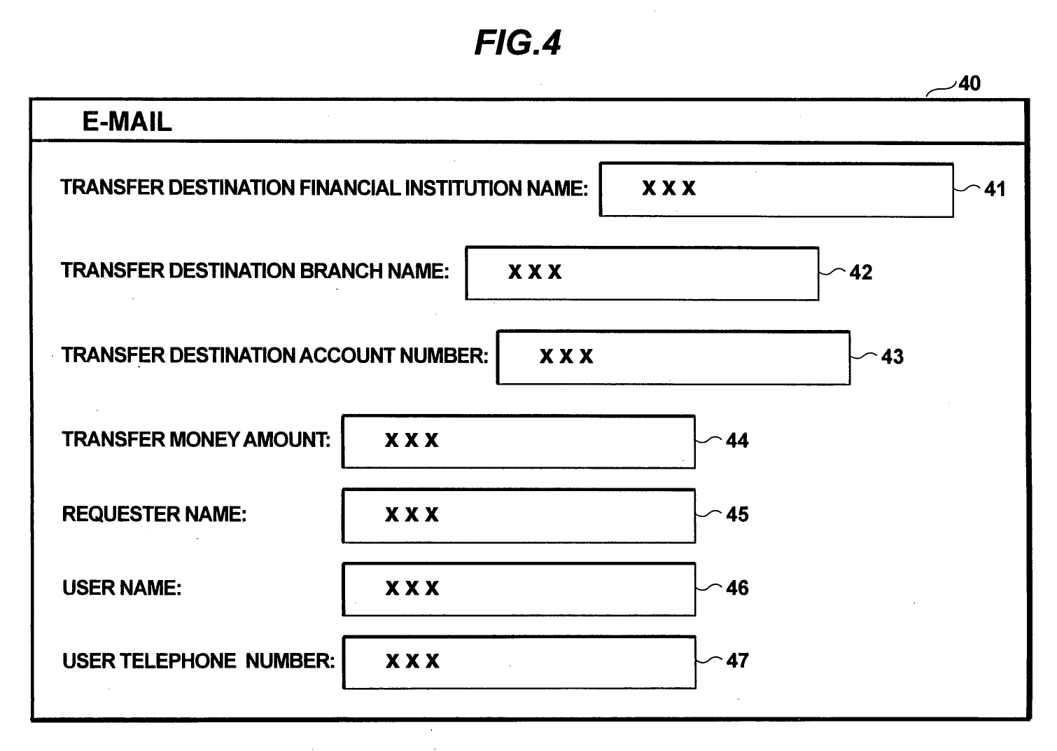

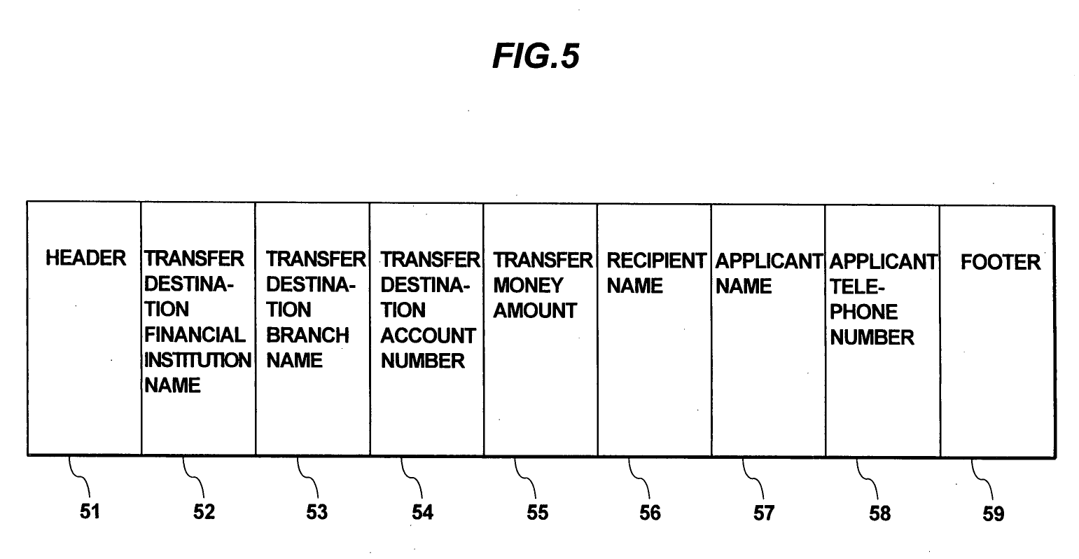

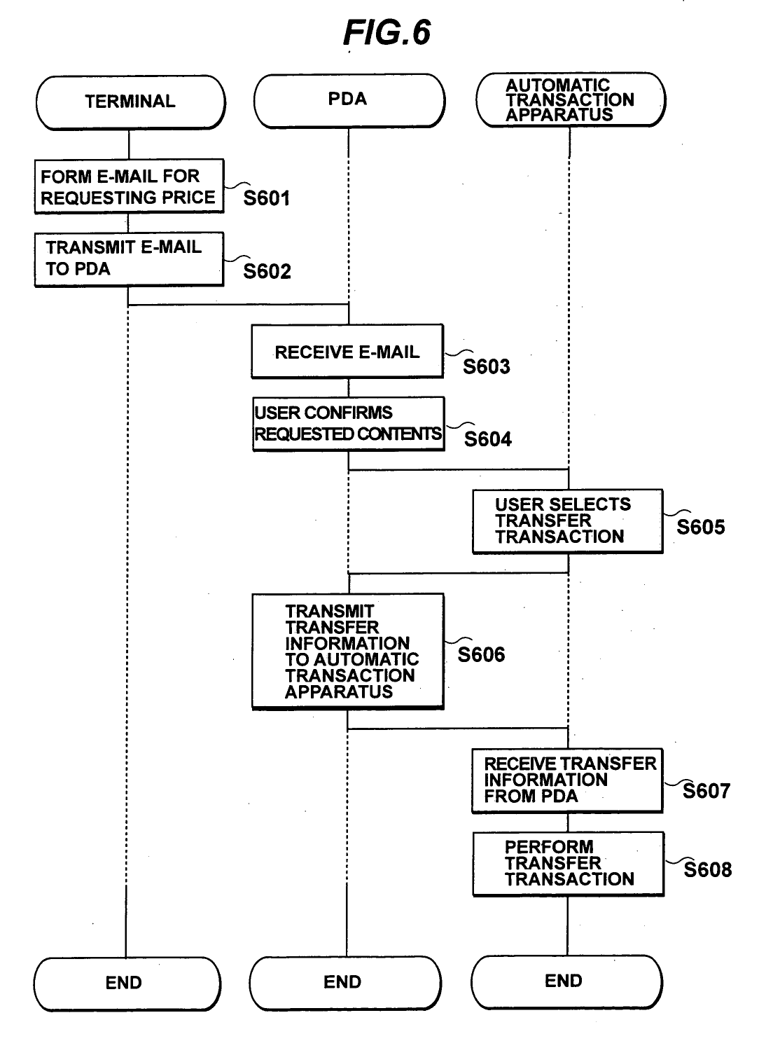

FIG. 1 is a block diagram of an automatic transaction system showing the first embodiment. FIG. 2 is a block diagram of an automatic transaction apparatus showing the first embodiment. FIG. 3 is a block diagram of a personal digital assistant (PDA) showing the first embodiment. FIG. 4 is an explanatory diagram of an E-mail display screen which is displayed on a terminal and shows the first embodiment. FIG. 5 is an explanatory diagram of a communication telegraphic message showing the first embodiment. FIG. 6 is a flowchart showing the first embodiment.

In FIG. 1, reference numeral 1 denotes an automatic transaction apparatus which is set in a financial institution such as a bank or the like, a transportation facility such as a station or the like, a convenience store, or the like. The user can execute a deposit transaction or a withdrawal transaction of cash, a transfer transaction, or the like by operating the automatic transaction apparatus 1. The automatic transaction apparatus 1 is connected to a host computer, which will be explained hereinafter, through a communication line 2 so that they can communicate with each other.

Reference numeral 3 denotes a host computer which is set in a business center or the like of the financial institution such as a bank or the like. The host computer 3 transmits and receives a telegraphic message of a transaction such as deposit, withdrawal, transfer, or the like to/from the automatic transaction apparatus 1 through the communication line 2 and discriminates whether or not the transaction of the user is settled. The host computer 3 also makes a personal identification to confirm that the user is the person himself.

Reference numeral 4 denotes a personal digital assistant (PDA) such as cellular phone, PHS (Personal Handyphone System) telephone, or the like which is operated by the user. The PDA 4 can make voice communication, electronic data communication, or the like with another apparatus through a network 5 and can also transmit and receive E-mail. Although the PDA 4 has a display screen to display various kinds of information such as received information and the like, operation buttons, a digital camera to read an image, and the like, their details will be described hereinafter.

Reference numeral 6 denotes a terminal which is operated by the person who requests the user to pay a price of a sold article or the like. The terminal 6 can communicate with the PDA 4 through the network 5. The terminal 6 has: arithmetic operating and control means such as CPU (Central Processing Unit), MPU (Micro Processing Unit), or the like; storing means such as magnetic disk, semiconductor memory, or the like; input means such as keyboard, mouse, or the like; display means such as CRT (Cathode Ray Tube), LCD (Liquid Crystal Display), or the like; communicating means; and the like. As a terminal 6, it is possible to use any type of terminal so long as it is connected to the PDA 4 through an arbitrary one of various networks such as wired or wireless public communication line network, dedicated line communication network, telephone line network, Internet, and the like so that it can communicate with the PDA 4. For example, a personal computer, a cellular phone, a personal digital assistant, a gaming machine, an on-vehicle navigation system, or the like can be mentioned.

In FIG. 2, the automatic transaction apparatus 1 has a user operation display unit 21, a deposit/withdrawal unit 22, a card reader/writer unit 23, a wireless communication control unit 24, and a control unit 25.

The user operation display unit 21 is constructed in such a manner that a touch panel is arranged on a display unit such as CRT display, liquid crystal display (LCD), or the like and the user executes the input operation or the like by using the display unit 21. The user operation display unit 21 displays a transaction selection display screen, a display screen for guiding the input operation or the like of the user for the transaction selected by the user, inputted information, or the like. It is also possible to construct in such a manner that transaction buttons such as “withdrawal”, “deposit”, “transfer”, and the like are displayed on the transaction selection display screen and the user executes a desired transaction by pressing those buttons.

The deposit/withdrawal unit 22 is constructed by a bill deposit/withdrawal apparatus and a coin deposit/withdrawal apparatus and executes a deposit/withdrawal process of a bill and coins in association with the transaction.

The card reader/writer unit 23 reads user information or the like such as an account number and the like from a magnetic stripe, an IC chip, or the like of a card inserted by the user.

The wireless communication control unit 24 is wireless communication means for controlling wireless communication with the personal digital assistant (PDA) 4. The transfer information or the like can be received from the PDA 4 by the wireless communication control unit 24. The wireless communication is, for example, short range wireless communication and can be made by using infrared communication, contactless IC communication, or the like.

The control unit 25 controls the operation of the whole automatic transaction apparatus 1 including the user operation display unit 21, deposit/withdrawal unit 22, card reader/writer unit 23, and wireless communication control unit 24 on the basis of software stored in a storing unit 251.

Reference numeral 252 denotes a transfer processing unit which performs the user's selected transfer transaction on the basis of the transfer information or the like received from the PDA 4 by the wireless communication control unit 24. The transfer information denotes a name of a transfer destination financial institution, a name of a transfer destination branch, a transfer destination account number, a transfer money amount, a name of the requester, a name of the user, and a telephone number of the user. The transfer transaction can be also executed by a method whereby the user inputs the transfer information by operating the user operation display unit 21.

Reference numeral 253 denotes a communication control unit which controls communication with the host computer 3 connected through the communication line 2. The personal identification of the user and the transaction such as transfer transaction or the like are executed through the communication control unit 253.

In FIG. 3, reference numeral 31 denotes a display unit such as a liquid crystal display or the like. The display unit 31 displays the information received by the PDA 4, the contents of the operation executed by the user, or the like.

Reference numeral 32 denotes an operation unit having a speech start button, a speech end button, numeral buttons, and the like. The user inputs information into the PDA 4 by the operation unit 32.

Reference numeral 33 denotes a voice processing unit having a microphone for inputting a transmitting voice, a recipient for outputting a received voice, and the like.

Reference numeral 34 denotes a camera unit such as a digital camera for photographing an image. The information code such as bar code, 2-dimensional code, or the like can be read by the camera unit 34.

Reference numeral 35 denotes a telephone communication control unit which executes processes regarding telephone communication with the network 5.

Reference numeral 36 denotes an antenna.

Reference numeral 37 denotes a wireless communication control unit serving as wireless communicating means which executes processes regarding wireless communication with the automatic transaction apparatus 1 or the like. The information read out of the information code such as a bar code or the like by the camera unit 34 can be transmitted to the automatic transaction apparatus 1 or the like by the wireless communication control unit 37. The information can be also received from the automatic transaction apparatus 1 or the like.

Reference numeral 38 denotes a control unit which controls the whole PDA 4 including the display unit 31, operation unit 32, voice processing unit 33, camera unit 34, telephone communication control unit 35, and wireless communication control unit 37.

In FIG. 4, reference numeral 40 denotes an example of an E-mail display screen. This display screen 40 is displayed on the display means by E-mail software of the terminal 6.

Reference numeral 41 denotes a transfer destination financial institution name as a name of the financial institution where the account of the requester to which the user is supposed to transfer exists.

Reference numeral 42 denotes a transfer destination branch name as a name of the head/branch office where the account of the requester to which the user is supposed to transfer exists.

Reference numeral 43 denotes a transfer destination account number serving as an account of the requester to which the user is supposed to transfer.

Reference numeral 44 denotes a transfer money amount as an amount of money to be transferred by the user to the account of the requester.

Reference numeral 45 denotes a requester name as a name of the person who requests the user to pay the price.

Reference numeral 46 denotes a user name as a name of the user who pays the price to the requester.

Reference numeral 47 denotes a user telephone number as a telephone number of the user who pays the price to the requester.

In FIG. 5, the communication telegraphic message which is transmitted from the PDA 4 to the automatic transaction apparatus 1 is constructed by, for example, a header 51, a transfer destination financial institution name 52, a transfer destination branch name 53, a transfer destination account number 54, a transfer money amount 55, a recipient name 56, an applicant name 57, an applicant telephone number 58, a footer 59, and the like.

The header 51 and the footer 59 are communication control information.

The transfer destination financial institution name 52 is the same information as the transfer destination financial institution name 41. The transfer destination branch name 53 is the same information as the transfer destination branch name 42. The transfer destination account number 54 is the same information as the transfer destination account number 43. The transfer money amount 55 is the same information as the transfer money amount 44. The recipient name 56 is the same information as the requester name 45. The applicant name 57 is the same information as the user name 46. The applicant telephone number 58 is the same information as the user telephone number 47.

The operation of the foregoing construction will now be described in accordance with processing steps each starting from “S” in a flowchart of FIG. 6 showing the first embodiment. The operation of each unit, which will be explained hereinbelow, is controlled by a control unit (not shown) on the basis of programs (software) stored in a storing unit (not shown).

S601:

When the user purchases an article or the like, a requester of the price of this article operates the terminal 6 and displays the E-mail display screen 40 to the display means by the E-mail software. The requester forms the transfer information by inputting the transfer destination financial institution name 41, transfer destination branch name 42, transfer destination account number 43, transfer money amount 44, requester name 45, user name 46, and user telephone number 47 on the E-mail display screen 40 by input means.

S602:

The requester executes the operation to transmit the formed transfer information by E-mail to an E-mail address of the PDA 4 possessed by the user by operating the terminal 6. By this operation, the terminal 6 transmits the transfer destination financial institution name 41, transfer destination branch name 42, transfer destination account number 43, transfer money amount 44, requester name 45, user name 46, user telephone number 47, and the like as transfer information to the PDA 4 of the user. As a data format of the transfer information which is transmitted by E-mail, any one of a text format, an HTML (Hyper Text Markup Language) format, an XML (eXtensible Markup Language) format, and the like can be used, or a format other than those formats can be also used.

S603:

The PDA 4 which received such E-mail stores the received transfer information into the storing unit (not shown). The user operates the operation unit 32 of the PDA 4 in which the transfer information has been stored, so that the PDA 4 allows the display unit 31 to display the transfer destination financial institution name 41, transfer destination branch name 42, transfer destination account number 43, transfer money amount 44, requester name 45, user name 46, user telephone number 47, and the like as the received transfer information.

S604:

The user confirms the requested contents such as transfer money amount, requester name, user name, user telephone number, and the like displayed on the display unit 31.

S605:

The user brings the PDA 4 which has received the transfer information and makes a transfer transaction by the automatic transaction apparatus 1 set in the financial institution or the like. First, the user selects “Transfer Transaction” on the transaction selection display screen displayed on the user operation display unit 21 of the automatic transaction apparatus 1. When “Transfer Transaction” is selected, the automatic transaction apparatus 1 starts the transfer transaction by the transfer processing unit 252. When the transfer transaction is started, the automatic transaction apparatus 1 allows the user operation display unit 21 to display a message for guiding the user to make the PDA 4 approach the wireless communication control unit 24 if he possesses the PDA 4 in which the transfer information has been stored.

S606:

The user makes the possessed PDA 4 approach the wireless communication control unit 24 and transmits the transfer information stored in the PDA 4. A format of the telegraphic message which is transmitted from the PDA 4 to the wireless communication control unit 24 is constructed by the transfer information such as header 51, transfer destination financial institution name 52, transfer destination branch name 53, transfer destination account number 54, transfer money amount 55, recipient name 56, applicant name 57, applicant telephone number 58, footer 59, and the like shown in FIG. 5.

S607:

The wireless communication control unit 24 notifies the control unit 25 of the transfer information received from the PDA 4. The notified control unit 25 stores it into the storing unit 251.

S608:

The transfer processing unit 252 reads out the transfer destination financial institution name 52, transfer destination branch name 53, transfer destination account number 54, transfer money amount 55, recipient name 56, applicant name 57, applicant telephone number 58, and the like as transfer information stored in the storing unit 251. Therefore, it becomes unnecessary for the user to execute the operation to input the transfer information by the user operation display unit 21.

The transfer processing unit 252 allows the user operation display unit 21 to display the read transfer information. The user confirms the displayed transfer information and presses a confirmation button. After that, the user makes an ordinary transfer transaction by cash, a credit card, or the like and completes the payment of the price of the purchased article or the like.

As described above, according to the first embodiment, since it becomes unnecessary for the user to execute the operation to input the transfer destination financial institution name, the transfer destination branch name, the transfer destination account number, the transfer money amount, the applicant name, and the applicant telephone number in the transfer transaction which is executed in the automatic transaction apparatus, such an effect that the operating time of the automatic transaction apparatus which is operated by the user can be shortened, the erroneous input can be reduced, and the operation burden on the user can be decreased is obtained.

Since the transfer information is transmitted by E-mail from the requester to the PDA possessed by the user, even in the case where the user does not visit the shop as in the mail-order sale or the like, the user can obtain such an effect that the input operating time of the transfer transaction which is executed by the automatic transaction apparatus can be shortened, the erroneous input can be reduced, and the operation burden on the user can be decreased.

Further, such an effect that the waiting line for the automatic transaction apparatus can be shortened is obtained.

Such an effect that a troublesomeness in which the requester writes and sends a bill and costs necessary for such an operation can be reduced is obtained. Such an effect that there is no need for the user to bring the received bill to an automatic transaction apparatus of a financial institution or the like is also obtained.

Further, such an effect that the transfer transaction can be performed as it is without editing the transfer information received by the PDA is obtained.

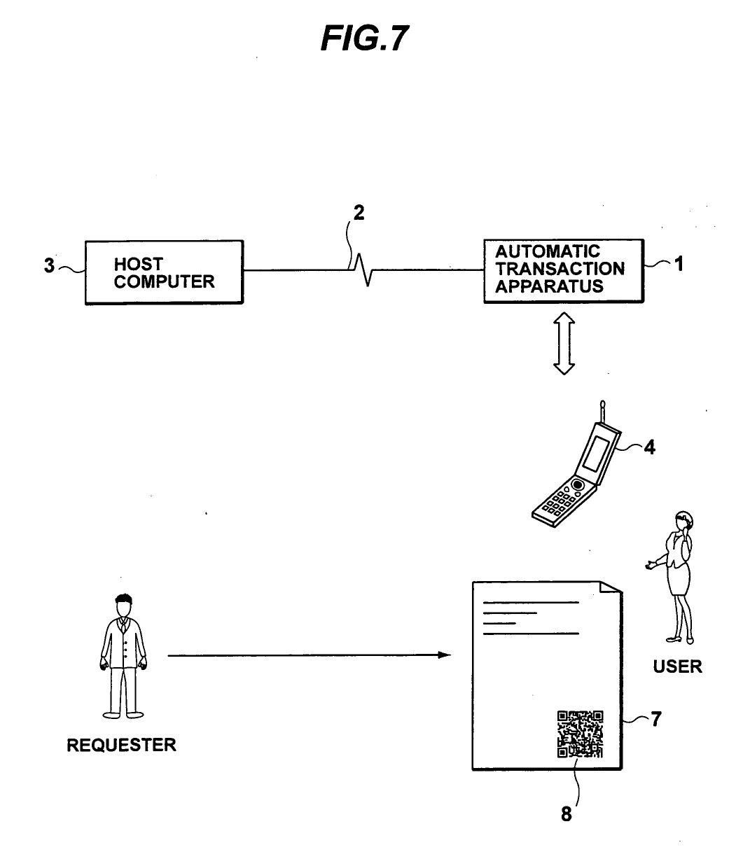

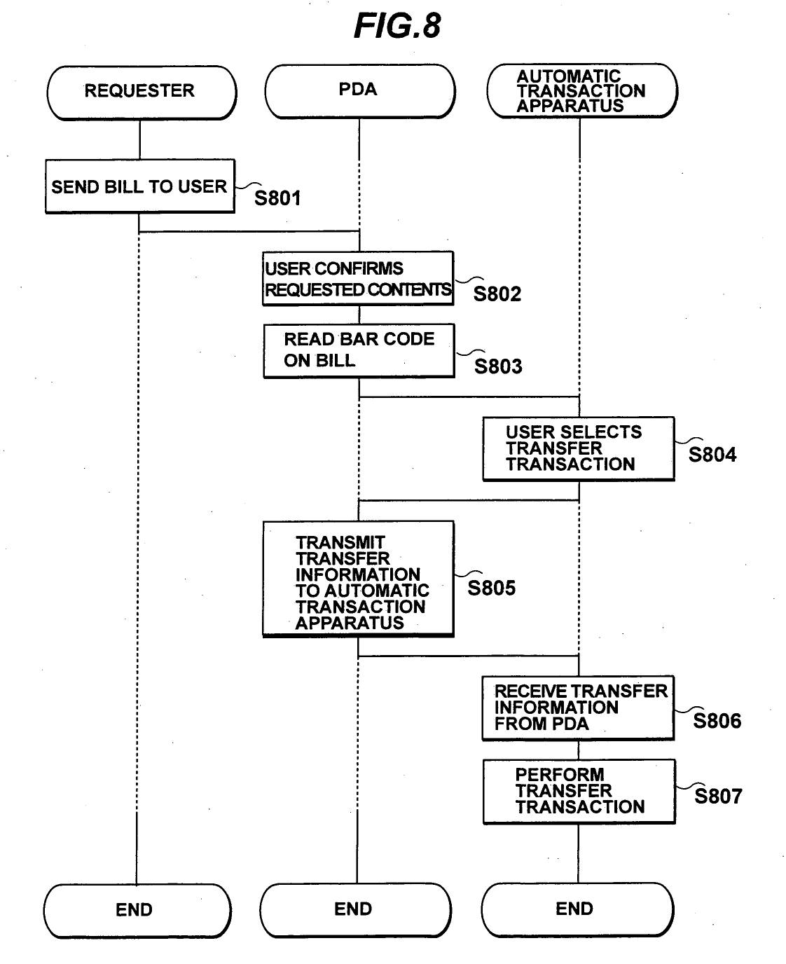

FIG. 7 is a block diagram of an automatic transaction system showing the second embodiment of the invention. FIG. 8 is a flowchart showing the second embodiment.

Portions similar to those in the foregoing first embodiment are designated by the same reference numerals and their description is omitted.

In FIG. 7, reference numeral 7 denotes a bill which is a written paper on which requested contents have been written and which is sent from the requester who requests a purchase price of an article or the like to the user who has purchased such an article or the like.

Reference numeral 8 denotes an information code such as bar code, 2-dimensional code, or the like in which the transfer destination financial institution name, the transfer destination branch name, the transfer destination account number, the transfer money amount, the recipient name, the applicant name, and the telephone number of the applicant have been converted into codes.

The operation of the foregoing construction will now be described in accordance with processing steps each starting from “S” in the flowchart of FIG. 8 showing the second embodiment. The operation of each unit, which will be explained hereinbelow, is controlled by a control unit (not shown) on the basis of the programs (software) stored in the storing unit (not shown).

S801:

When the user purchases an article or the like, the requester of a price for this article makes the bill 7 on which the information code 8 has been printed. The transfer destination financial institution name, the transfer destination branch name, the transfer destination account number, the transfer money amount, the requester name, the user name, the telephone number of the user, and the like are printed on the bill 7. In the information code 8, the information such as transfer destination financial institution name, transfer destination branch name, transfer destination account number, transfer money amount, requester name, user name, and telephone number of the user have been converted into the codes. The requester sends the formed bill 7 to the user.

Although the embodiment will be described with respect to an example in which the user name and the user telephone number are included in the information code 8, the user can directly input those information by using the PDA 4 or it is also possible to input them from the user operation display unit 21 in the transfer transaction of the automatic transaction apparatus 1.

S802:

The user confirms the requested contents written on the bill 7.

S803:

The user operates the PDA 4 and reads the information code 8 printed on the bill 7 by the camera unit 34. The PDA 4 demodulates the read information code 8 into the transfer information such as transfer destination financial institution name, transfer destination branch name, transfer destination account number, transfer money amount, requester name, user name, telephone number of the user, and the like and stores the demodulated transfer information into the storing unit (not shown). The PDA 4 allows the display unit 31 to display the read transfer destination financial institution name, transfer destination branch name, transfer destination account number, transfer money amount, requester name, user name, telephone number of the user, and the like.

The user confirms the requested contents such as transfer money amount, requester name, user name, telephone number of the user, and the like displayed on the display unit 31.

S804:

The user brings the PDA 4 in which the transfer information has been stored and performs the transfer transaction in the automatic transaction apparatus 1 set in the financial institution or the like. First, the user selects the transfer transaction on the transfer selection display screen displayed in the user operation display unit 21 of the automatic transaction apparatus 1. When the transfer transaction is selected, the automatic transaction apparatus 1 starts the transfer transaction by the transfer processing unit 252. When the transfer transaction is started, if the user has the PDA 4 in which the transfer information has been stored, the automatic transaction apparatus 1 allows the user operation display unit 21 to display the message for guiding the user to make the PDA 4 approach the wireless communication control unit 24.

S805:

The user makes the possessed PDA 4 approach the wireless communication control unit 24 so that the transfer information stored in the PDA 4 is transmitted. A data format of the transfer information which is transmitted from the PDA 4 to the wireless communication control unit 24 is constructed by the transfer information such as header 51, transfer destination financial institution name 52, transfer destination branch name 53, transfer destination account number 54, transfer money amount 55, recipient name 56, applicant name 57, applicant telephone number 58, footer 59, and the like.

S806:

The wireless communication control unit 24 notifies the control unit 25 of the transfer information received from the PDA 4. The notified control unit 25 stores it into the storing unit 251.

S807:

The transfer processing unit 252 reads out the transfer destination financial institution name 52, transfer destination branch name 53, transfer destination account number 54, transfer money amount 55, recipient name 56, applicant name 57, and applicant telephone number 58 as the transfer information stored in the storing unit 251. Therefore, there is no need for the user to execute the operation to input the transfer information by the user operation display unit 21.

The transfer processing unit 252 allows the user operation display unit 21 to display the read-out transfer information. The user confirms the displayed transfer information and presses the confirmation button. After that, the user performs the ordinary transfer transaction by cash, a credit card, or the like and completes the payment of the price of the purchased article or the like.

As described above, according to the second embodiment, since it becomes unnecessary for the user to execute the operation to input the transfer destination financial institution name, the transfer destination branch name, the transfer destination account number, the transfer money amount, the applicant name, and the applicant telephone number in the transfer transaction which is executed in the automatic transaction apparatus, such an effect that the operating time of the automatic transaction apparatus which is operated by the user can be shortened, the erroneous input can be reduced, and the operation burden on the user can be decreased is obtained.

Since the information code printed on the bill sent from the requester to the user is read out by the PDA and demodulated into the transfer information, even in the case where the user does not visit the shop as in the mail-order sale or the like, the user can obtain such an effect that the input operating time of the transfer transaction which is executed by the automatic transaction apparatus can be shortened, the erroneous input can be reduced, and the operation burden on the user can be decreased.

Further, such an effect that the waiting line for the automatic transaction apparatus can be shortened is obtained.

Such an effect that the transfer transaction can be performed as it is without editing the transfer information read by the PDA is also obtained.

The present invention is not limited to the foregoing embodiments but many modifications and variations are possible within the spirit and scope of the appended claims of the invention.

What is claimed is:

1. A transfer transaction method comprising the steps of:
allowing a terminal to transmit inputted transfer information to a personal digital assistant by communicating means;
allowing said personal digital assistant which has received said transfer information to transmit said transfer information to an automatic transaction apparatus by wireless communicating means; and
allowing said automatic transaction apparatus to perform a transfer transaction in accordance with the transfer information received by said wireless communicating means.

2. The transfer transaction method according to claim 1, wherein said transfer information is a transfer destination financial institution name, a transfer destination branch name, a transfer destination account number, a transfer money amount, a requester name, a user name, and a telephone number of the user.

3. The transfer transaction method according to claim 1, wherein said wireless communicating means is short range wireless communication such as infrared communication, contactless IC communication.

4. A transfer transaction method comprising the steps of:
reading an information code printed on a bill by a personal digital assistant;
transmitting transfer information obtained by demodulating said information code to an automatic transaction apparatus by wireless communicating means; and
allowing said automatic transaction apparatus to perform a transfer transaction in accordance with the transfer information received by said wireless communicating means.

5. The transfer transaction method according to claim 4, wherein said transfer information is a transfer destination financial institution name, a transfer destination branch name, a transfer destination account number, a transfer money amount, a requester name, a user name, and a telephone number of the user.

6. The transfer transaction method according to claim 4, wherein said wireless communicating means is short range wireless communication such as infrared communication, contactless IC communication.

7. A transfer transaction system comprising:
a personal digital assistant which includes a control unit which, when transfer information that is transmitted from a terminal is received, allows said transfer information to be stored into a storing unit; and a wireless communicating means which transmits the transfer information in said storing unit to an automatic transaction apparatus,
wherein said automatic transaction apparatus includes a wireless communication control unit which, when said transmitted transfer information is received, allows said transfer information to be stored into a storing unit; and a transfer processing unit which fetches the transfer information from said storing unit and executes a transfer process.

8. The transfer transaction system according to claim 7, wherein said transfer information is a transfer destination financial institution name, a transfer destination branch name, a transfer destination account number, a transfer money amount, a requester name, a user name, and a telephone number of the user.

9. The transfer transaction system according to claim 7, wherein said wireless communicating means is short range wireless communication such as infrared communication, contactless IC communication.

10. A transfer transaction system comprising:
a personal digital assistant which includes a code reading means which reads an information code indicative of transfer information printed on a bill, and a wireless communicating means which converts said read information code into the transfer information and transmits said converted transfer information to an automatic transaction apparatus,
wherein said automatic transaction apparatus includes a wireless communication control unit which, when said transmitted transfer information is received, allows said received transfer information to be stored into a storing unit; and a transfer processing unit which fetches the transfer information from said storing unit and executes a transfer process.

11. The transfer transaction system according to claim 10, wherein said transfer information is a transfer destination financial institution name, a transfer destination branch name, a transfer destination account number, a transfer money amount, a requester name, a user name, and a telephone number of the user.

12. The transfer transaction system according to claim 10, wherein said wireless communicating means is short range wireless communication such as infrared communication, contactless IC communication.
